(19) United States
(12) Patent Application Publication
(10) Pub. No.: US 2022/0118378 A1
(43) Pub. Date: Apr. 21, 2022

(54) BUBBLE MACHINE WITH CAMERA FUNCTION

(71) Applicant: GUIJUAN DU, NANCHONG (CN)

(72) Inventor: GUIJUAN DU, NANCHONG (CN)

(21) Appl. No.: 17/566,722

(22) Filed: Dec. 31, 2021

(51) Int. Cl. A63H 33/28; H04N 5/225

(52) U.S. Cl. CPC A63H 33/28; H04N 5/2252

(57) ABSTRACT

The present invention discloses a bubble machine with a camera function, and relates to the technical field of bubble machines. In the present invention, a bubble machine and a digital camera merge into one device by fixedly arranging the digital camera and the bubble machine in a housing, which is more convenient for people to carry out. On the other hand, in the present invention, after bubbles are blown out, people use the digital camera to take pictures to achieve simultaneous processes, which is more convenient for people to take pictures or record videos while blowing bubbles.

### TECHNICAL FIELD

The present invention relates to the technical field of bubble machines, in particular to a bubble machine with a camera function.

### BACKGROUND

A bubble machine, as an entertainment device, is suitable for people of all ages to play. When going out to play, some people are desirable to take pictures or record videos simultaneously when using the bubble machine at the same time, so as to record a variety of wonderful moments with bubbles as decoration. However, bubble machines in the prior art are relatively single in functions, and can generally only blow bubbles. To achieve the above mentioned functions, both bubble machine and camera are needed to carry on, which brings inconvenience for carrying and using.

### SUMMARY

The present invention aims to provide a bubble machine with a camera function, which realizes convenient pictures or videos taking while blowing bubbles, and is more convenient for people to carry out.

In order to realize the above purpose, the present invention adopts the following technical solution:

a bubble machine with a camera function comprises a housing, a digital camera and a bubble machine, the digital camera and the bubble machine are both fixedly arranged in the housing;

the bubble machine comprises a driving mechanism, a blowing mechanism, a liquid outlet mechanism, a bubble ring and a rotating rod, the driving mechanism respectively drives the blowing mechanism and the liquid outlet mechanism to work, the blowing mechanism and the liquid outlet mechanism respectively cooperate with the bubble ring, a bubble outlet is provided on the bubble ring, and the liquid outlet mechanism drives the rotating rod to rotate in the manner of sticking to the bubble outlet.

Further, the driving mechanism comprises a power supply, a switch and a double-headed motor, and the power supply, the switch and the double-headed motor are electrically connected in series in sequence.

Further, the blowing mechanism comprises a blower and an induced draught pipeline, the double-headed motor drives the blower to rotate, the blower blows air into the induced draught pipeline, and the induced draught pipeline communicates with the bubble outlet.

Further, the liquid outlet mechanism comprises a liquid storage tank, a gear assembly, a liquid pumping pipe, an extrusion chamber and extrusion wheels, the double-headed motor drives the gear assembly to rotate, the gear assembly respectively drives the rotating rod and the extrusion wheels to rotate, the end face that the bubble ring closes to the bubble outlet defines an annular liquid outlet groove, the bottom of the liquid outlet groove is provided with a liquid outlet hole, one end of the liquid pumping pipe extends into the liquid storage tank, and the other end communicates with the liquid outlet hole, the extrusion wheels are pivotally connected in the extrusion chamber, the middle portion of the liquid pumping pipe is wound in the extrusion chamber, and the extrusion wheels cooperate with the inner wall of the extrusion chamber to extrude the liquid pumping pipe.

Further, the liquid outlet mechanism further comprises a collection pipe, the periphery of the bubble ring is fixedly provided with a collection ring around, the lower portion of the collection ring defines a collection hole, one end of the collection pipe communicates with the collection hole, and the other end communicates with the interior of the liquid storage tank.

Further, a memory card is installed on one side of the digital camera.

The present invention has the following beneficial effects: in the present invention, a bubble machine and a digital camera merge into one device by fixedly arranging the digital camera and the bubble machine in a housing, which is more convenient for people to carry out. On the other hand, in the present invention, bubble liquid is provided to a bubble ring by means of a liquid outlet mechanism, the liquid outlet mechanism drives a rotating rod to rotate to scrape the bubble liquid at a bubble outlet such that a film is formed thereby, and a driving mechanism drives a blowing mechanism to blow air, so that the film seals a certain amount of air when leaving the bubble ring to form a bubble. After bubbles are blown out, people use the digital camera to take pictures to achieve simultaneous processes, which is more convenient for people to take pictures or record videos while blowing bubbles.

### BRIEF DESCRIPTION OF THE DRAWINGS

FIG. 1 is a schematic diagram of the overall structure of the present invention;

FIG. 2 is a schematic diagram of the internal structure of the housing of the present invention;

FIG. 3 is a schematic diagram of partial structure inside the bubble machine of the present invention;

FIG. 4 is a schematic diagram of partial structure of the bubble machine of the present invention;

FIG. 5 is a schematic diagram of the internal structure of the bubble machine of the present invention;

FIG. 6 is a schematic structural diagram of the extrusion chamber of the present invention; and

FIG. 7 is a schematic structural diagram of the bubble ring and the collection ring of the present invention; and

Reference number listing is as follows:

housing 1, digital camera 2, bubble machine 3

driving mechanism 31, power supply 311, switch 312, double-headed motor 313

blowing mechanism 32, blower 321, induced draught pipeline 322

liquid outlet mechanism 33, liquid storage tank 331, gear assembly 332, liquid pumping pipe 333, collection pipe 334, extrusion chamber 335, extrusion wheel 336

bubble ring 34, bubble outlet 341, liquid outlet groove 342, liquid outlet hole 343

rotating rod 36

collection ring 37, and collection hole 371.

### DETAILED DESCRIPTION

The present invention will be further described below in conjunction with drawings.

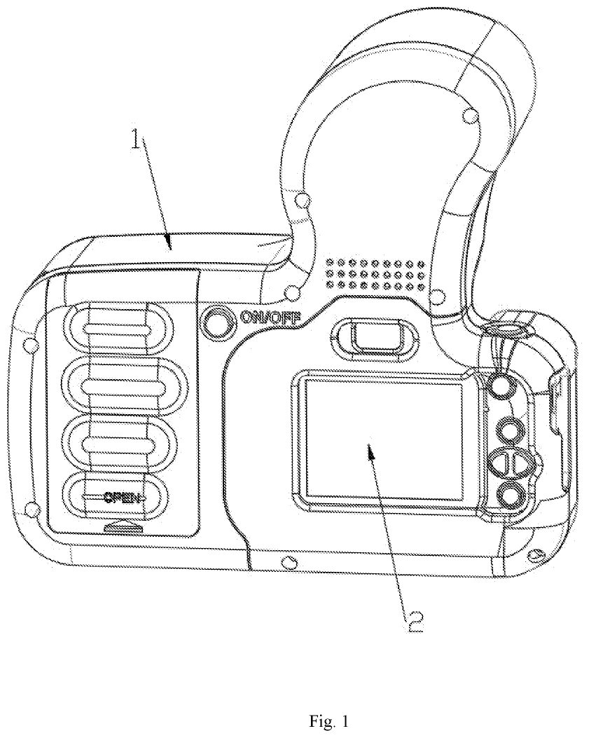

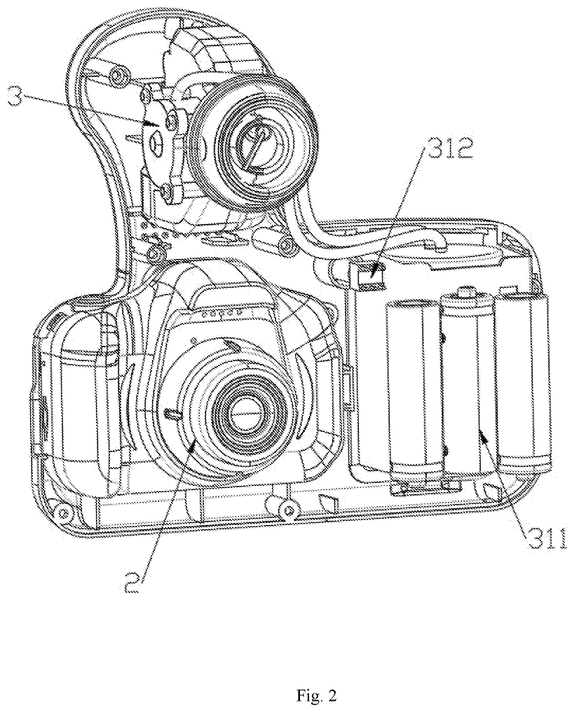

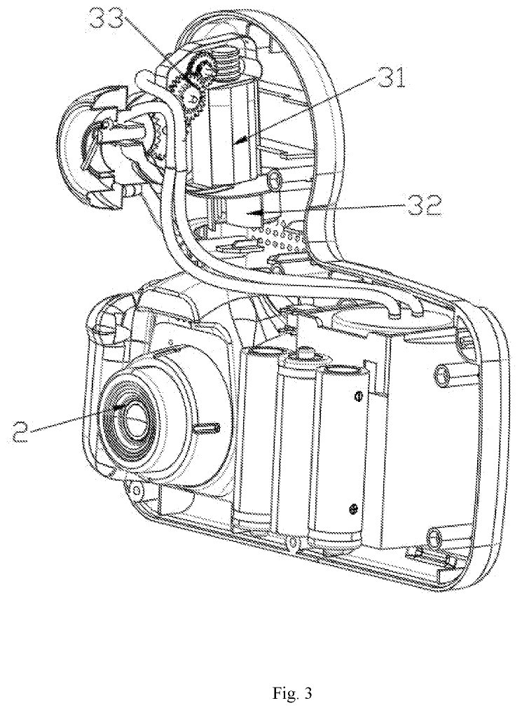

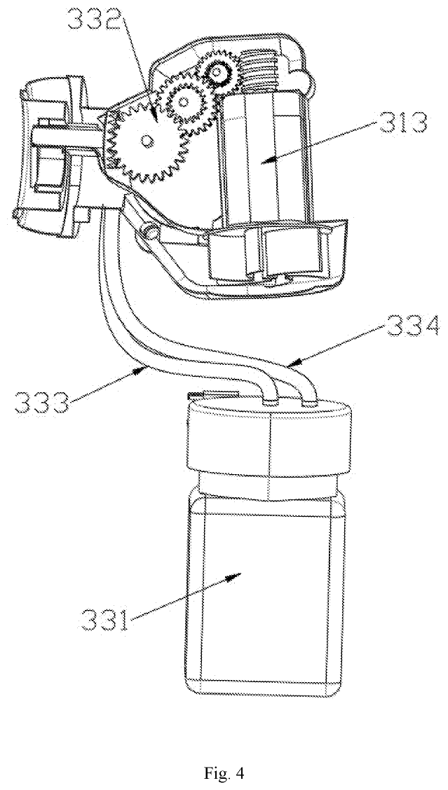

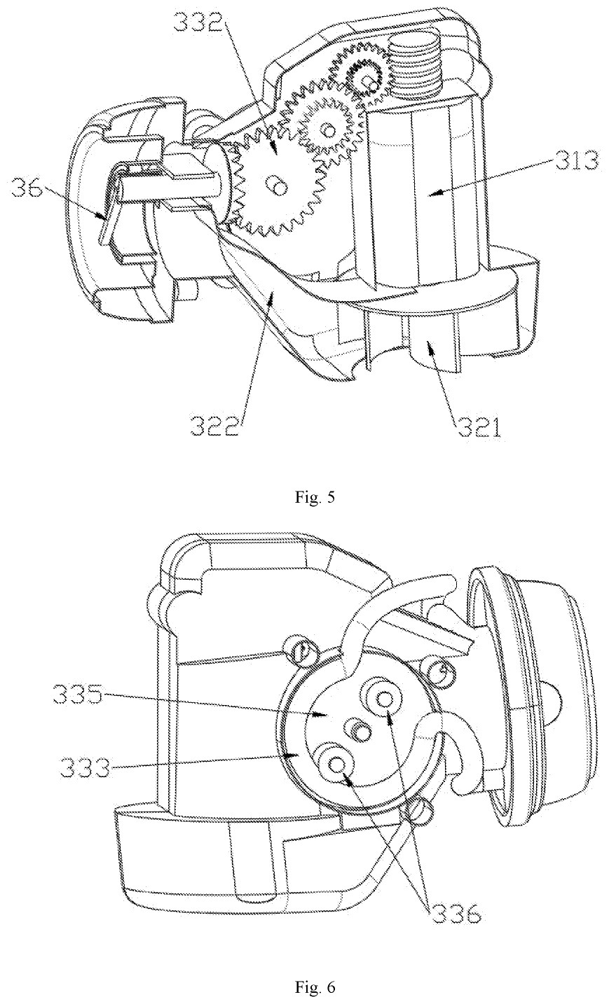

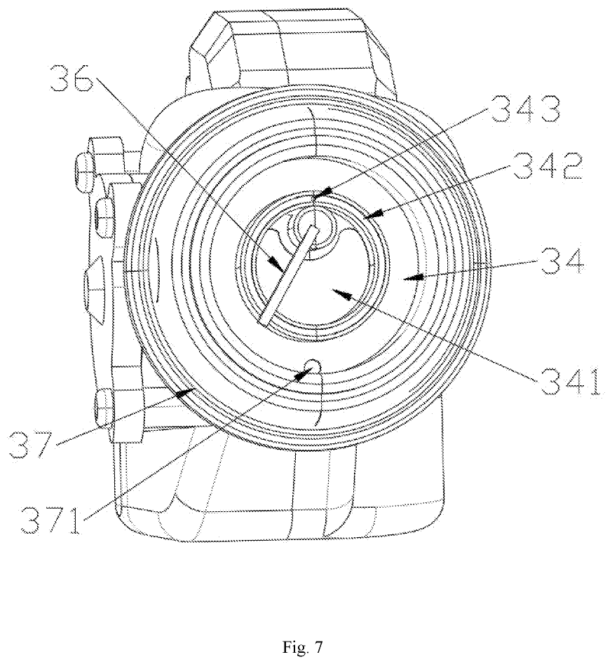

A bubble machine with a camera function is as shown in FIG. 1 to FIG. 6, comprising a housing 1, a digital camera 2 and a bubble machine 3, wherein the digital camera 2 and the bubble machine 3 are both fixedly arranged in the housing 1, and the bubble machine 3 and the digital camera 2 merge into one device by fixedly arranging the digital camera 2 and the bubble machine 3 in the housing 1, which is more convenient for people to carry out and use.

A memory card is installed on one side of the digital camera 2 to enable storage of data such as photos and videos, so that the digital camera 2 can take pictures or record videos.

The bubble machine 3 comprises a driving mechanism, a blowing mechanism, a liquid outlet mechanism, a bubble ring 34 and a rotating rod 36, the driving mechanism respectively drives the blowing mechanism and the liquid outlet mechanism to work, the blowing mechanism and the liquid outlet mechanism respectively cooperate with the bubble ring 34, a bubble outlet 341 is provided on the bubble ring 34, and the liquid outlet mechanism drives the rotating rod 36 to rotate in the manner of sticking to the bubble outlet 341.

The driving mechanism comprises a power supply 311, a switch 312 and a double-headed motor 313, the power supply 311, the switch 312 and the double-headed motor 313 are electrically connected in series in sequence, the power supply 311 supplies power to the double-headed motor 313, and the switch 312 is used to control the power on or off of a circuit.

The blowing mechanism comprises a blower 321 and an induced draught pipeline 322, the double-headed motor 313 drives the blower 321 to rotate, the blower 321 blows air into the induced draught pipeline 322, the induced draught pipeline 322 communicates with the bubble outlet 341, and when the blower 321 is working, air is blown into the induced draught pipeline 322, and is guided to the bubble outlet 341 to be blown out through the induced draught pipeline 322.

The liquid outlet mechanism comprises a liquid storage tank 331, a gear assembly 332, a liquid pumping pipe 333, a collection pipe 334, an extrusion chamber 335 and extrusion wheels 336, there are two sets of the extrusion wheels 336, the double-headed motor 313 drives the gear assembly 332 to rotate, the gear assembly 332 respectively drives the rotating rod 36 and the extrusion wheels 336 to rotate, the end face that the bubble ring 34 closes to the bubble outlet 341 defines an annular liquid outlet groove 342, the bottom of the liquid outlet groove 342 is provided with a liquid outlet hole 343, one end of the liquid pumping pipe 333 extends into the liquid storage tank 331, and the other end communicates with the liquid outlet hole 343, the extrusion wheels 336 are pivotally connected in the extrusion chamber 335, the middle portion of the liquid pumping pipe 333 is wound in the extrusion chamber 335, and the extrusion wheels 336 cooperate with the inner wall of the extrusion chamber 335 to extrude the liquid pumping pipe 333.

When the gear assembly 332 drives the extrusion wheels 336 to rotate, the extrusion wheels 336 and the inner wall of the extrusion chamber 335 cooperate with each other to extrude the liquid pumping pipe 333 in turn, in the process of being extruded and restored, a continuous negative pressure is generated inside the liquid pumping pipe 333 to pump the bubble liquid in the liquid storage tank 331 to the liquid outlet hole 343, the bubble liquid flows into the liquid outlet groove 342 through the liquid outlet hole 343, the gear assembly 332 drives the rotating rod 36 to rotate to scrape the bubble liquid at the bubble outlet 341 such that a film is formed thereby, the double-headed motor 313 drives the blower 321 to rotate, and when the blower 321 is working, air is blown into the induced draught pipeline 322, and is guided to the bubble outlet 341 to be blown out through the induced draught pipeline 322, so that the film seals a certain amount of air when leaving the bubble ring 34 to form a bubble.

The periphery of the bubble ring 34 is fixedly provided with a collection ring 37 around, the lower portion of the collection ring 37 defines a collection hole 371, one end of the collection pipe 334 communicates with the collection hole 371, and the other end communicates with the interior of the liquid storage tank 331.

Excess bubble liquid in the liquid outlet groove 342 drips under gravity, and falls within the collection ring 37, and the bubble liquid in the collection ring 37 flows into the collection pipe 334 through the collection hole 371, and finally flows back into the liquid storage tank 331 through the collection pipe 334, thus avoiding waste of the bubble liquid.

The working principle of the present invention lies in that:

1. the drive mechanism drives the gear assembly 332 to work, when the gear assembly 332 drives the extrusion wheels 336 to rotate, the extrusion wheels 336 and the inner wall of the extrusion chamber 335 cooperate with each other to extrude the liquid pumping pipe 333 in turn, in the process of being extruded and restored, a continuous negative pressure is generated inside the liquid pumping pipe 333 to pump the bubble liquid in the liquid storage tank 331 to the liquid outlet hole 343, the bubble liquid flows into the liquid outlet groove 342 through the liquid outlet hole 343, and the gear assembly 332 drives the rotating rod 36 to rotate to scrape the bubble liquid at the bubble outlet 341 such that a film is formed thereby;

2. the double-headed motor 313 drives the blower 321 to rotate, and when the blower 321 is working, air is blown into the induced draught pipeline 322, and is guided to the bubble outlet 341 to be blown out through the induced draught pipeline 322, so that the film seals a certain amount of air when leaving the bubble ring 34 to form a bubble; and

3. excess bubble liquid in the liquid outlet groove 342 drips under gravity, and falls within the collection ring 37, and the bubble liquid in the collection ring 37 flows into the collection pipe 334 through the collection hole 371, and finally flows back into the liquid storage tank 331 through the collection pipe 334, thus avoiding waste of the bubble liquid; and after bubbles are blown out, people use the digital camera 2 to take pictures to achieve simultaneous processes, which is more convenient for people to take pictures or record videos while blowing bubbles.

The above is not to limit the technical scope of the present invention in any way, any modifications, equivalent changes and modifications made to the above embodiments according to the technical essence of the present invention still fall within the scope of the technical solution of the present invention.

1. A bubble machine with a camera function, characterized in comprising a housing, a digital camera and a bubble machine, wherein the digital camera and the bubble machine are both fixedly arranged in the housing;
the bubble machine comprises a driving mechanism, a blowing mechanism, a liquid outlet mechanism, a bubble ring and a rotating rod, wherein the driving mechanism respectively drives the blowing mechanism and the liquid outlet mechanism to work, the blowing mechanism and the liquid outlet mechanism respectively cooperate with the bubble ring, a bubble outlet is provided on the bubble ring, and the liquid outlet mechanism drives the rotating rod to rotate in the manner of sticking to the bubble outlet.

2. The bubble machine with a camera function according to claim 1, wherein the driving mechanism comprises a power supply, a switch and a double-headed motor, and the power supply, the switch and the double-headed motor are electrically connected in series in sequence.

3. The bubble machine with a camera function according to claim 2, wherein the blowing mechanism comprises a blower and an induced draught pipeline, the double-headed motor drives the blower to rotate, the blower blows air into the induced draught pipeline, and the induced draught pipeline communicates with the bubble outlet.

4. The bubble machine with a camera function according to claim 2, wherein the liquid outlet mechanism comprises a liquid storage tank, a gear assembly, a liquid pumping pipe, an extrusion chamber and extrusion wheels; the double-headed motor drives the gear assembly to rotate, the gear assembly respectively drives the rotating rod and the extrusion wheels to rotate, the end face that the bubble ring closes to the bubble outlet defines an annular liquid outlet groove, the bottom of the liquid outlet groove is provided with a liquid outlet hole, one end of the liquid pumping pipe extends into the liquid storage tank, and the other end communicates with the liquid outlet hole, the extrusion wheels are pivotally connected in the extrusion chamber, the middle portion of the liquid pumping pipe is wound in the extrusion chamber, and the extrusion wheels cooperate with the inner wall of the extrusion chamber to extrude the liquid pumping pipe.

5. The bubble machine with a camera function according to claim 4, wherein the liquid outlet mechanism further comprises a collection pipe, the periphery of the bubble ring is fixedly provided with a collection ring around, the lower portion of the collection ring defines a collection hole, one end of the collection pipe communicates with the collection hole, and the other end communicates with the interior of the liquid storage tank.

6. The bubble machine with a camera function according to claim 1, wherein a memory card is installed on one side of the digital camera.
